(19) United States
(12) Patent Application Publication
(10) Pub. No.: US 2013/0060949 A1
(43) Pub. Date: Mar. 7, 2013

(54) COMMUNICATION CONTROL APPARATUS THAT CONTROLS SESSION ESTABLISHMENT, CONTROL METHOD THEREFOR, AND STORAGE MEDIUM

(71) Applicant: Kyohei Takeda, Kawasaki-shi (JP)

(72) Inventor: Kyohei Takeda, Kawasaki-shi (JP)

(73) Assignee: CANON KABUSHIKI KAISHA, Tokyo (JP)

(21) Appl. No.: 13/572,946

(22) Filed: Aug. 13, 2012

(30) Foreign Application Priority Data
Sep. 7, 2011 (JP) 2011-195043

(51) Int. Cl. G06F 15/16

(52) U.S. Cl. 709/227

(57) ABSTRACT

A communication control apparatus which is capable of transmitting a message to a plurality of destinations by broadcasting using SIP, and also avoiding a situation in which other SIP services cannot be used. A connection request message received from a transmitting-side terminal apparatus via a network is transmitted to destinations associated with an address included in a connection request message. It is determined whether or not a predetermined designation is made as to the connection request message, and when it is determined that the predetermined designation is made as to the connection request message, response messages are received from all receiving-side terminal apparatuses which are the destinations, then a connection response message is transmitted to the transmitting-side terminal apparatus, and all the receiving-side terminal apparatuses which are the destinations and the transmitting-side terminal apparatus are connected to each other by one session.

### BACKGROUND OF THE INVENTION

1. Field of the Invention

The present invention relates to a communication control apparatus that controls session establishment between terminal devices connected to a network, and in particular to a communication control apparatus that controls session establishment according to SIP (session initiation protocol), a control method therefor, and a computer-readable storage medium storing a control program for implementing the method.

2. Description of the Related Art

In general, SIP is known as a protocol which establishes a virtual session between terminal apparatuses connected to a network and ensures communication services while the session is established. This SIP is used for communication services such as IP (internet protocol) phone calls and IP-FAX.

When a SIP session is to be established, first, a transmitting-side terminal apparatus transmits a SIP session establishment request (INVITE) to a receiving-side terminal apparatus. The receiving-side terminal apparatus returns a success response in response to the received INVITE to the transmitting-side terminal apparatus. Upon receiving the success response, the transmitting-side terminal apparatus transmits ACK (acknowledgement) to the receiving-side terminal apparatus so that a SIP session can be established.

Also, to determine media for use in the SIP session, the transmitting-side terminal apparatus and the receiving-side terminal apparatus exchange SDP (session description protocol) in which, for example, port numbers through which media desired to be used are received are described (SDP negotiation).

In the SDP negotiation, the transmitting-side terminal apparatus transmits an INVITE including an offer SDP to the receiving-side terminal apparatus. Then, the receiving-side terminal apparatus returns a success response including an answer SDP to the transmitting-side terminal apparatus.

According to the SIP, a plurality of destinations can be registered with respect to one SIP URI (SIP uniform resource identifier). A SIP server, which is a communication control apparatus, is provided with a so-called fork function using SIP URI, and when a transmitting-side terminal apparatus transmits a SIP connection request (INVITE) to a SIP URI for which a plurality of destinations are registered, the SIP server transmits a SIP connection request (INVITE) to all the registered destinations.

On this occasion, a SIP session is established only in a receiving-side terminal apparatus which returned a success response first, and a cancel is transmitted from the SIP server to other receiving-side terminal apparatuses (see, for example, Japanese Laid-Open Patent Publication (Kokai) No. 2005-269574).

There has been a demand that transmission be completed within a short period of time by communicating simultaneously with a plurality of destinations particularly in a case where a fax is transmitted to the plurality of destinations using the SIP. However, there may be cases where the number of SIP sessions that can be established simultaneously is limited in view of a situation in which resources for establishing SIP sessions are limited.

For example, in a case where the maximum number of connections (the number of SIP sessions) that can be established simultaneously is limited to three in the SIP, when a fax is transmitted to three receiving-side terminal apparatus using fax broadcasting, all of the three SIP sessions are occupied. As a result, other SIP services such as IP phone cannot be used.

FIG. 10 is a diagram useful in explaining exemplary communication using the fork function by the conventional SIP. Here, image forming apparatuses having a communication function are given as examples of terminal apparatuses.

In the example shown in the figure, image forming apparatuses 101 and 103 to 106 which are exemplary terminal apparatuses and a SIP server 102 which is an exemplary communication control apparatus are connected together via a network. Assume now that the image forming apparatus 101 transmits an image as a medium to a plurality of destinations. Here, when the image is to be transmitted to the plurality of destinations, the fork function mentioned above is used.

First, the image forming apparatus 101 transmits a SIP connection request message (INVITE) to a SIP URI (here, XXX@abc.co.jp) for which the plurality of destinations are registered (S901). In response to this, the SIP server 102 transmits the SIP connection request message to all the registered destinations (S902).

In the example shown in the figure, the maximum number of connections that can be established simultaneously (the number of SIP sessions) is three, and here, the SIP server 102 transmits the SIP connection request message to the image forming apparatuses 103 to 105.

The fork function cancels connection to image forming apparatuses other than an image forming apparatus that returned a success response first. In the example shown in FIG. 10, because the image forming apparatus 103 returns a success response (OK) to the SIP server 102 first (S903), the SIP server 102 transmits a CANCEL to the image forming apparatuses 104 and 105 (S904). A message to this effect is then transmitted from the SIP server 102 to the image forming apparatus 101.

Thus, a SIP session is established between the image forming apparatus 103 that returned the response first and the image forming apparatus 101, and a fax is transmitted between the image forming apparatus 103 and the image forming apparatus 101 (S905). As a result, an image forming apparatus cannot communicate with a plurality of image forming apparatuses simultaneously by broadcasting.

Namely, to communicate with the plurality of image forming apparatuses 103 to 105 simultaneously, the image forming apparatus 101 has to establish a plurality of SIP sessions. When the plurality of SIP sessions are established, other SIP services may not be used if the number of SIP sessions is limited.

### SUMMARY OF THE INVENTION

The present invention provides a communication control apparatus capable of transmitting a message to a plurality of destinations by broadcasting using SIP, and also avoiding a situation in which other SIP services cannot be used, a control method therefor, and a computer-readable storage medium storing a control program for implementing the method.

Accordingly, a first aspect of the present invention provides a communication control apparatus that establishes a session in response to a connection request message received from a transmitting-side terminal apparatus via a network, and controls communication between the transmitting-side terminal apparatus and receiving-side terminal apparatuses, comprising a transmission unit configured to transmit a connection request message to destinations associated with an address included in the connection request message, a determination unit configured to determine whether a predetermined designation is made as to the connection request message, and a session establishment unit configured to, when the determination unit determines that the predetermined designation is made as to the connection request message, receive response messages from all of the receiving-side terminal apparatuses which are the destinations, then transmits a connection response message to the transmitting-side terminal apparatus, and connects all of the receiving-side terminal apparatuses which are the destinations and the transmitting-side terminal apparatus to each other by one session.

Accordingly, a second aspect of the present invention provides a control method for a communication control apparatus that establishes a session in response to a connection request message received from a transmitting-side terminal apparatus via a network, and controls communication between the transmitting-side terminal apparatus and receiving-side terminal apparatuses, comprising a transmission step of transmitting a connection request message to destinations associated with an address included in the connection request message, a determination step of determining whether a predetermined designation is made as to the connection request message, and a session establishment step of, when it is determined in the determination step that the predetermined designation is made as to the connection request message, receiving response messages from all of the receiving-side terminal apparatuses which are the destinations, then transmitting a connection response message to the transmitting-side terminal apparatus, and connecting all of the receiving-side terminal apparatuses which are the destinations and the transmitting-side terminal apparatus to each other by one session.

Accordingly, a third aspect of the present invention provides a non-transitory computer-readable storage medium storing a control program for implementing a control method for a communication control apparatus that establishes a session in response to a connection request message received from a transmitting-side terminal apparatus via a network, and controls communication between the transmitting-side terminal apparatus and receiving-side terminal apparatuses, comprising a transmission step of transmitting a connection request message to destinations associated with an address included in the connection request message, a determination step of determining whether a predetermined designation is made as to the connection request message, and a session establishment step of, when it is determined in the determination step that the predetermined designation is made as to the connection request message, receiving response messages from all of the receiving-side terminal apparatuses which are the destinations, then transmitting a connection response message to the transmitting-side terminal apparatus, and connecting all of the receiving-side terminal apparatuses which are the destinations and the transmitting-side terminal apparatus to each other by one session.

According to the present invention, even in a case where a message is broadcasted to a plurality of receiving-side terminal apparatuses, the plurality of receiving-side terminal apparatuses and a transmitting-side terminal apparatus can be connected together by one SIP session. Therefore, even when the maximum number of SIP sessions is limited, it is possible to avoid a situation in which a plurality of SIP sessions are used in broadcasting and other SIP services cannot be used.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of a network to which a SIP server which is an exemplary communication control apparatus according to a first embodiment of the present invention is connected.

FIG. 2 is a block diagram schematically showing a hardware arrangement of an image forming apparatus appearing in FIG. 1.

FIG. 3 is a block diagram schematically showing exemplary software operating in the image forming apparatus and the SIP server appearing in FIG. 1.

FIG. 4 is a sequence diagram useful in explaining session establishment in the network appearing in FIG. 1.

FIG. 5 is a flowchart useful in explaining session establishment in the image forming apparatus appearing in FIG. 1.

FIG. 6 is a flowchart useful in explaining session establishment in the SIP server appearing in FIG. 1.

FIG. 7 is a view useful in explaining exemplary SIP addresses registered in a SIP URI storage section appearing in FIG. 3.

FIG. 8 is diagram useful in explaining other exemplary SIP addresses registered in the SIP URI storage section appearing in FIG. 3 according to a second embodiment of the present invention.

FIG. 9 is a flowchart useful in explaining session establishment in a SIP server according to a third embodiment of the present invention.

FIG. 10 is a diagram useful in explaining exemplary communication using a fork function by a conventional SIP.

### DESCRIPTION OF THE EMBODIMENTS

A description will now be given of a communication control apparatus according to embodiments of the present invention with reference to the drawings.

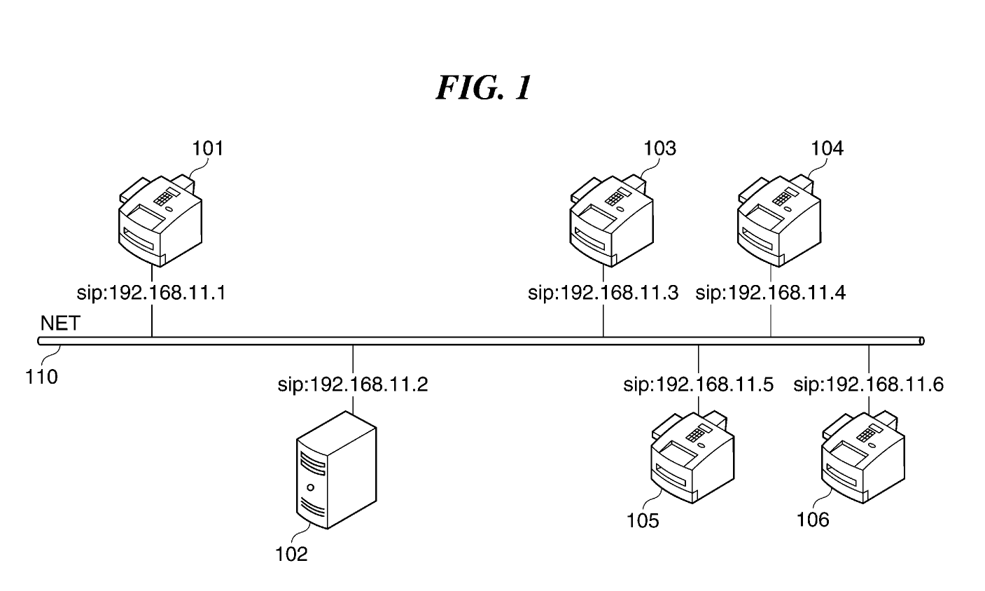

FIG. 1 is a diagram schematically showing an arrangement of a network to which a SIP server which is an exemplary communication control apparatus according to a first embodiment of the present invention is connected.

Referring to FIG. 1, image forming apparatuses 101 and 103 to 106 which are exemplary terminal apparatuses and have a communication function are connected to a network NET 110. Further, a SIP (session initiation protocol) server 102 which is an exemplary communication control apparatus is connected to the network NET 110. In the example shown in the figure, although there are the five image forming apparatuses 101 and 103 to 106, at least three image forming apparatuses are connected to the network NET 110.

Each of the image forming apparatuses 101 and 103 to 106 has a SIP function. The image forming apparatuses 101 and 103 to 106 and the SIP server 102 are capable of communicating with each other and have respective SIP addresses.

In the example shown in FIG. 1, it is assumed that the SIP address of the image forming apparatus 101 is “sip: 192.168.11.1”, and the SIP address of the SIP server 102 is “sip: 192.168.11.2”. It is also assumed that the SIP address of the image forming apparatus 103 is “sip: 192.168.11.3”, and the SIP address of the image forming apparatus 104 is “sip: 192.168.11.4”. It is also assumed that the SIP address of the image forming apparatus 105 is “sip: 192.168.11.5”, and the SIP address of the image forming apparatus 106 is “sip: 192.168.11.6”.

For the SIP server 102, a plurality of SIP addresses are associated with one SIP address (also referred to as the main SIP address). For example, at least two SIP addresses are associated with the main SIP address (for example, sip: xxx@abc.co.jp).

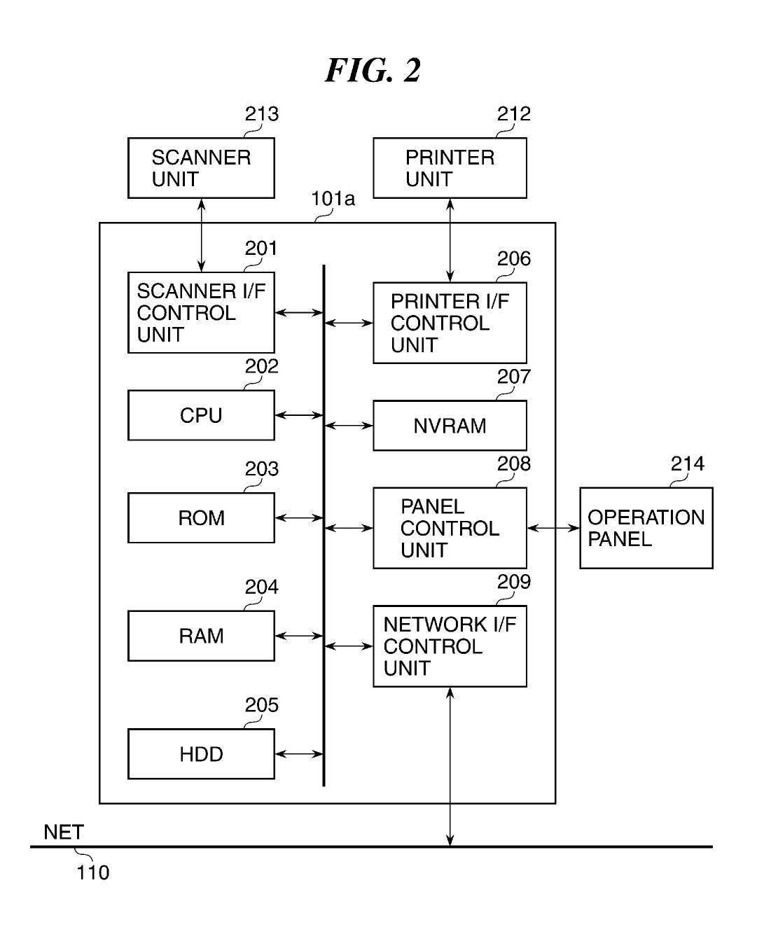

FIG. 2 is a block diagram schematically showing a hardware arrangement of the image forming apparatus 101 appearing in FIG. 1. It should be noted that each of the image forming apparatuses 103 to 106 also has the same arrangement as that of the image forming apparatus 101.

Referring to FIG. 2, the image forming apparatus 101 has a control unit 101a, a scanner 213, and a printer unit 212. The scanner 213 optically reads an image off an original to output image data. The printer unit 212 forms an image on a recording sheet according to the image data under the control of the control unit 101a.

The control unit 101a has a scanner I/F control unit 201, which controls the scanner 213. A CPU 202 executes software programs to control the image forming apparatus 101. A boot program, fixed parameters, and so on are stored in a ROM 203. A RAM 204 is used as, for example, a work area for the CPU 202. An HDD (hard disk drive) 205 is used to store various data such as print data (image data).

A printer I/F control unit 206 controls the printer unit 212. An NVRAM (nonvolatile memory) 207 stores various setting values for the image forming apparatus 101. A panel control unit 208 controls an operation panel 214 to display various information on the operation panel 214 and receive instructions input by a user. A network I/F control unit 209 controls data transmission and reception to and from the NET 110.

It should be noted that the scanner I/F control unit 201, the CPU 202, the ROM 203, the RAM 204, the HDD 205, the printer I/F control unit 206, the NVRAM 207, the panel control unit 208, and the network IF control unit 209 are connected together by a bus 210 in the control unit 101a.

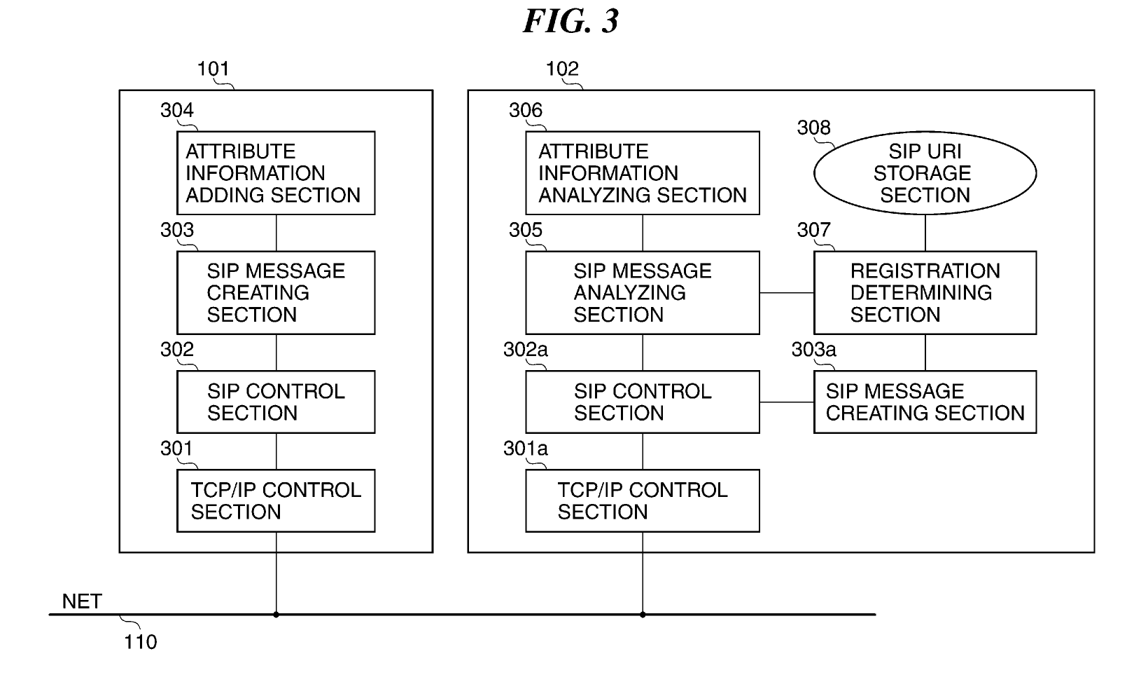

FIG. 3 is a block diagram schematically showing exemplary software operating in the image forming apparatus 101 and the SIP server 102 appearing in FIG. 1. It should be noted that each of the image forming apparatuses 103 to 106 also has the same software as the software which the image forming apparatus 101 has. Moreover, the software operates on a CPU which the image forming apparatus 101 has or a CPU which the SIP server 102 has.

In the image forming apparatus 101, a TCP/IP (transmission control protocol/internet protocol) control section 301 has a TCP/IP function and a UDP/IP (user datagram protocol/internet protocol) function, and controls data transmission and reception to and from other communication apparatuses on the network NET 110.

A SIP control section 302 transmits and receives SIP packets (also referred to as SIP data) to and from communication apparatuses being present on the network NET 110 via the TCP/IP control section 301 so as to perform a SIP session establishing process.

A SIP message creating section 303 creates a SIP message (that is, a SIP packet) such as a SIP connection request message (INVITE). An attribute information adding section 304 adds attribute information to a SIP message when adding a special definition to the SIP message.

A TCP/IP control section 301a, a SIP control section 302a, and a SIP message creating section 303a operate on the SIP server 102a. The TCP/IP control section 301a, the SIP control section 302a, and the SIP message creating section 303a have the same functions as the respective functions which the TCP/IP control section 301, the SIP control section 302, and the SIP message creating section 303 described above have.

In the SIP server 102, a SIP message analyzing section 305 analyzes a received SIP message, and when attribute information is added to the SIP message, an attribute information analyzing section 306 is used to analyze the attribute information.

A registration determining section 307 determines whether or not a SIP URI indicative of a destination is registered in a SIP URI storage section 308 according to the result of analysis by the SIP message analyzing section 305. It should be noted that the SIP URI storage section 308 is a memory (storage unit) provided in the SIP server 102.

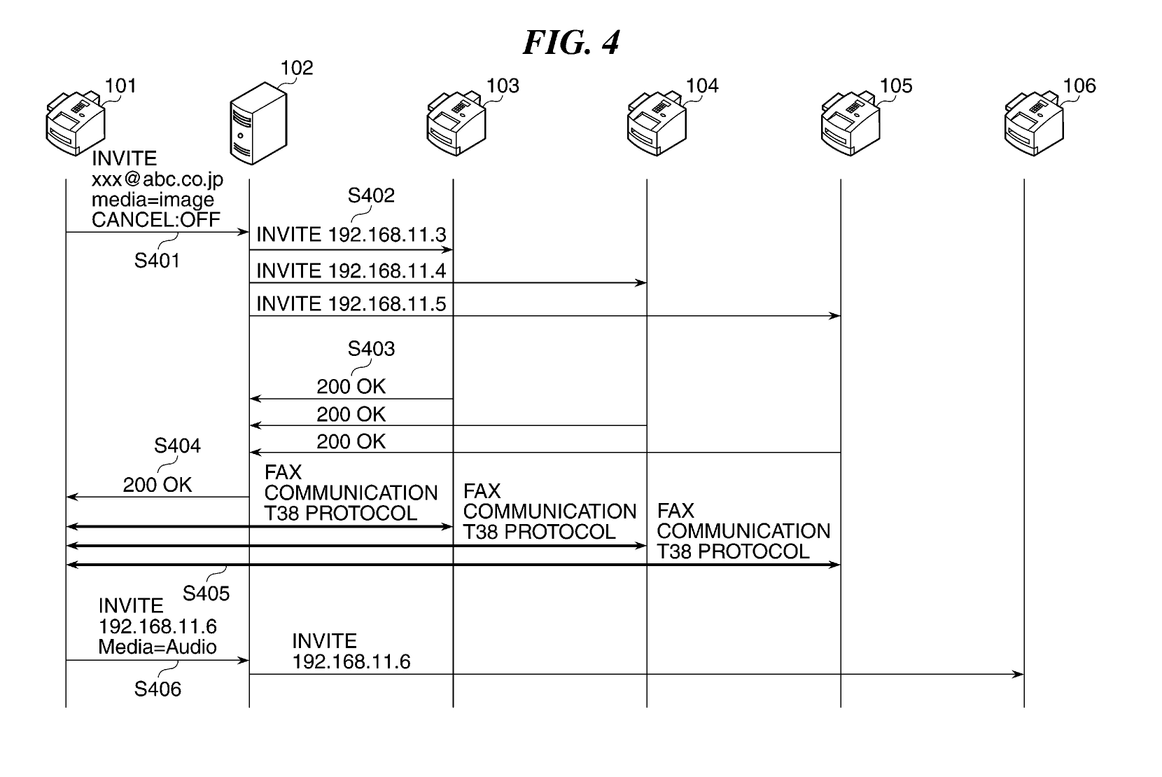

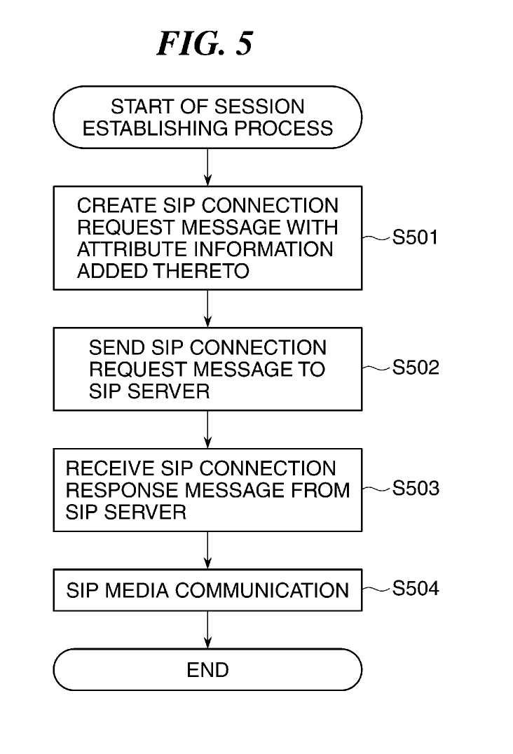

FIG. 4 is a sequence diagram useful in explaining session establishment in the network appearing in FIG. 1. FIG. 5 is a flowchart useful in explaining session establishment in the image forming apparatus 101 appearing in FIG. 1.

Here, a description will be given of an example in which the image forming apparatus 101 makes an IP phone call to the image forming apparatus 106 while broadcasting a fax to the image forming apparatuses 103 to 105. It should be noted that here, the maximum number of SIP sessions is limited to three.

Referring to FIGS. 3 to 5, in the image forming apparatus 101, first, the SIP message creating section 303 creates a SIP connection request message (INVITE) so as to broadcast a fax. On this occasion, the SIP message creating section 303 sets a SIP address “sip: xxx@abc.co.jp” as a destination and also sets m=image as a media type. Further, the attribute information adding section 304 sets an attribute indicative of cancellation (CANCEL), which is additional attribute information, to OFF and adds this attribute information to the SIP connection request message (step S501).

The SIP control section 302 transmits the SIP connection request message to the SIP server 102 via the TCP/IP control section 301 (step S502 or S401).

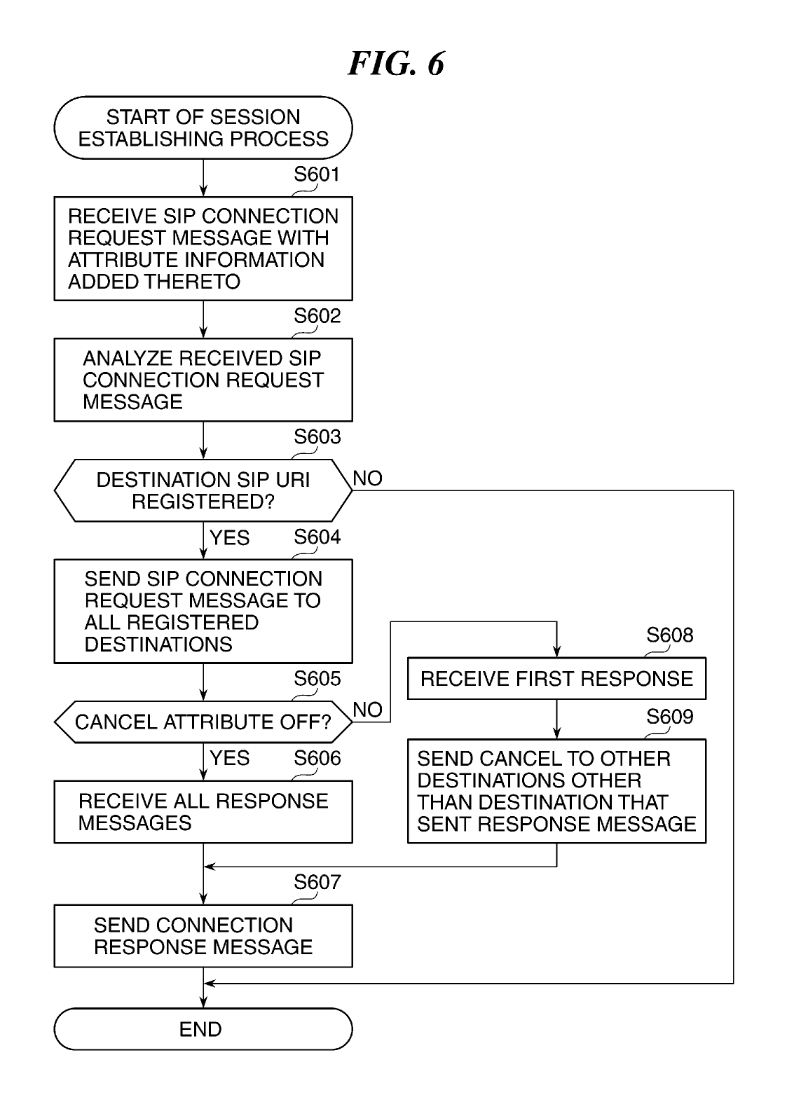

FIG. 6 is a flowchart useful in explaining session establishment in the SIP server 102 appearing in FIG. 1.

In the SIP server 102, the SIP control section 302a receives a SIP connection request message via the TCP/IP control section 301a (step S601). Then, the SIP message analyzing section 305 analyzes the SIP connection request message (step S602).

On this occasion, when there is additional attribute information, the attribute information analyzing section 306 analyzes the attribute information as will be described later. In the example shown in the figure, the attribute information analyzing section 306 determines whether an attribute indicative of CANCEL is ON or OFF.

Then, in order to ascertain whether or not SIP URIs indicative of destinations of the SIP message have already been registered, the SIP message analyzing section 305 instructs the registration determining section 307 to make a determination as to registration. By referring to the SIP URI storage section 308, the registration determining section 307 determines whether or not destination addresses for the SIP message have already been registered.

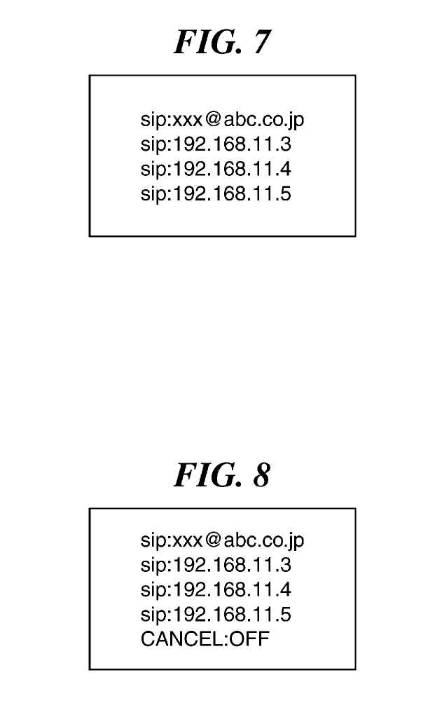

FIG. 7 is a view useful in explaining exemplary SIP addresses registered in the SIP URI storage section 308 appearing in FIG. 3.

As shown in FIG. 7, a SIP address “sip: xxx@abc.co.jp” is registered, and in association with this SIP address “sip: xxx@abc.co.jp”, three SIP addresses “sip: 192.168.11.3”, “sip: 192.168.11.4”, and “sip: 192.168.11.5” are registered.

When the registration determining section 307 determines that no destination address has been registered (NO in the step S603), the SIP message analyzing section 305 brings the session establishing process to an end.

On the other hand, when the registration determining section 307 determines that the destination addresses have been registered (YES in the step S603), the SIP control section 302a transmits a SIP connection request message (INVITE) to all the three addresses via the TCP/IP control section 301b (step S604 or S402). After transmitting the SIP connection request message, the SIP server 102 waits for response messages from the respective destinations.

Then, the SIP message analyzing section 305 determines whether or not an attribute indicative of CANCEL (CANCEL attribute) added to the SIP connection request message transmitted from the image forming apparatus 101 is OFF (step S605) using the attribute information analyzing section 306.

When the CANCEL attribute is OFF (YES in the step S605), the SIP message creating section 303a waits until it receives response messages from all the destinations (that is, three destinations here) (step S606 or S403).

Upon receiving response messages (OK) from all the destinations, the SIP message creating section 303a creates a connection response message. Then, the SIP control section 302a transmits the connection response message to the image forming apparatus 101 via the TCP/IP control section 301a (step S607 or S404) and brings the session establishing process to an end.

On the other hand, when the CANCEL attribute is ON (NO in the step S605), the SIP message creating section 303a waits until it receives a first response message (step S608). After receiving the first response message, the SIP message creating section 303a creates a cancel request message to request cancellation of the session establishing process.

The SIP control section 302a transmits, via the TCP/IP control section 301a, the cancel request message to the destinations except for the destination from which the response message was received (step S609). The process then proceeds to the step S607.

Referring to FIG. 5, in the image forming apparatus 101, the SIP control section 302 receives the connection response message (step S503). When the connection response message is received, one SIP session is established with the number of connections (the number of destinations) n (in the example shown in the figure, n=1 or 3) corresponding to the connection response message.

The image forming apparatus 101 causes the SIP control section 302 and the TCP/IP control section 301 to start SIP media communication (here, FAX communication) (step S504). Then, the session establishing process by the image forming apparatus 101 is brought to an end.

As described above, when the image forming apparatus 101 sets the CANCEL attribute to OFF, the SIP server 102 establishes one SIP session with the number of connections being equal to three. Thus, the image forming apparatus 101 can broadcast a fax to the image forming apparatuses 103 to 105 simultaneously (S405).

On the other hand, when the CANCEL attribute is ON, one SIP session is established with the number of connections being equal to one. On this occasion, in order to transmit a fax to the image forming apparatuses 103 to 105, the image forming apparatus 101 transmits the fax by establishing one session for each destination. Thus, when the CANCEL attribute is ON, the SIP server 102 has to establish three SIP sessions so that the image forming apparatus 101 can transmit a fax to the image forming apparatuses 103 to 105.

Here, however, at the time of transmitting a fax to the image forming apparatuses 103 to 105 with three SIP sessions established, the image forming apparatus 101 cannot establish another SIP session and make an IP phone call to the image forming apparatus 106 because the maximum number of SIP sessions is limited to three.

On the other hand, as described earlier, by setting the CANCEL to OFF, the image forming apparatus 101 can transmit a fax to the image forming apparatuses 103 to 105 simultaneously by one SIP session. While transmitting the fax, the image forming apparatus 101 can establish another SIP session and make an IP phone call to the image forming apparatus 106 with a media type is set to Media=Audio (S406).

As is clear from the above description, when there is no attribute information, a fork function of the SIP server 102 transmits a SIP connection request message (INVITE) to all registered destinations in a case where a plurality of destinations are registered as SIP URIs. A cancel message is transmitted to destinations other than a destination from which a response message was received first.

In the first embodiment, whether or not the SIP server is to make the above described cancellation is determined according to whether the CANCEL attribute which is attribute information is ON or OFF, and therefore, by setting the CANCEL attribute to OFF, a message can be broadcasted to a plurality of destinations with one SIP session established for them.

Next, a description will now be given of a SIP server according to a second embodiment of the present invention. It should be noted that an image forming apparatus and the SIP server according to the second embodiment have the same arrangements as those described with reference to FIGS. 1 to 3, and therefore, description thereof is omitted. Moreover, each of the image forming apparatuses 101 to 106 does not have to be equipped with the attribute information adding section 304.

In the first embodiment, the CANCEL attribute which is attribute information is added to a SIP connection request message (INVITE), but in the second embodiment, the CANCEL attribute is registered as attribute information in advance in the SIP URI storage section 308 when SIP URIs are registered.

FIG. 8 is a view useful in explaining other exemplary SIP addresses registered in the SIP URI storage section 308 appearing in FIG. 3 according to the second embodiment of the present invention.

Referring to FIG. 8, in association with a SIP address “sip: xxx@abc.co.jp”, three destinations are registered as SIP addresses (SIP URIs). Further, the CANCEL attribute is registered here in association with the SIP addresses.

In the second embodiment, at the time of creating a SIP connection request message so as to transmit a fax, the image forming apparatus 101 sets the SIP address (sip: xxx@abc.co.jp) as a destination without adding the CANCEL attribute as attribute information.

Further, the image forming apparatus 101 sets m=image as a media type in creating the SIP connection request message. This SIP connection request message is then transmitted from the image forming apparatus 101 to the SIP server 102.

In the SIP server 102, the SIP control section 302 receives the SIP connection request message via the TCP/IP control section 301. Then, the SIP message analyzing section 305 analyzes the SIP connection request message. On this occasion, because no attribute information (CANCEL attribute) is included in the SIP connection request message, attribute information is not analyzed.

Then, in order to ascertain whether or not SIP URIs indicative of destinations have already been registered, the SIP message analyzing section 305 instructs the registration determining section 307 to make a determination as to registration. The registration determining section 307 determines whether or not destinations of the SIP message have already been registered in the SIP URI storage section 308.

In this case, the registration determining section 307 determines that in association with the SIP address “sip: xxx@abc.co.jp”, three SIP addresses “sip: 192.168.11.3”, “sip: 192.168.11.4”, and “sip: 192.168.11.5” are registered. Further, the registration determining section 307 ascertains that the CANCEL attribute is registered, and passes the CANCEL attribute to the SIP message analyzing section 205.

Then, the SIP message analyzing section 305 causes the attribute information analyzing section 306 to analyze the CANCEL attribute which is attribute information. In the example shown in FIG. 8, because the CANCEL attribute is OFF, subsequent processing is performed in the same manner as in the first embodiment described above.

Thus, in the second embodiment as well, as with the first embodiment described above, for example, not only a fax can be broadcasted to a plurality of destinations, but also a IP phone call can be made while a fax is being broadcasted.

Next, a description will be given of an exemplary SIP server according to a third embodiment of the present invention. It should be noted that an image forming apparatus and the SIP server according to the third embodiment have the same arrangements as those described with reference to FIGS. 1 to 3, and therefore, description thereof is omitted.

In the first and second embodiments described above, the CANCEL attribute is used, and processing to be carried out by the SIP server 102 so as to establish a session varies according to whether the CANCEL attribute is ON or OFF.

In the third embodiment, a special ALLSEND (send to all) message as well as a SIP connection request message (INVITE) is defined. Here, by defining ALLSEND as well as INVITE for SIP messages, and upon receiving the ALLSEND message including a plurality of destinations, the SIP server 102 waits for response messages from all the destinations and does not issue a cancel.

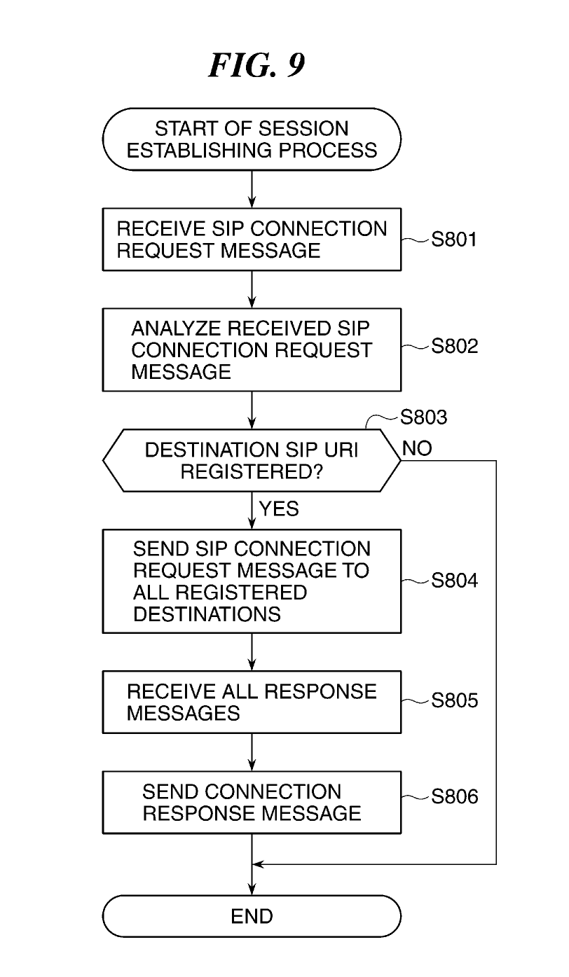

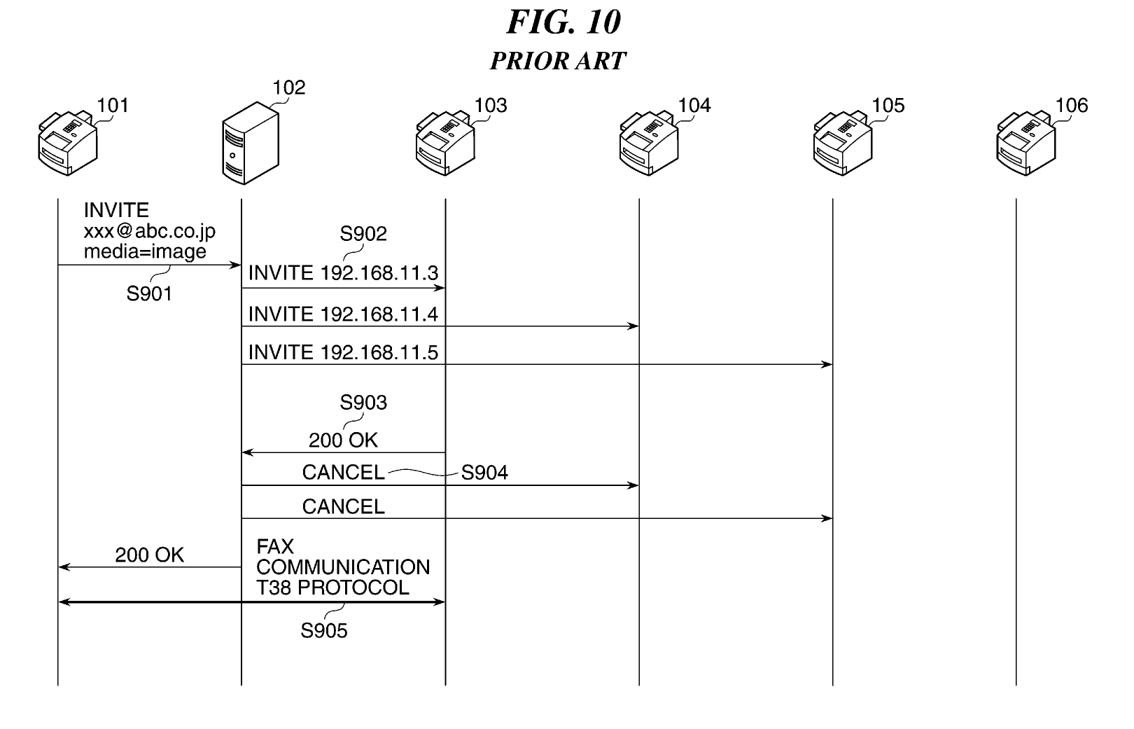

FIG. 9 is a flowchart useful in explaining session establishment in the SIP server according to the third embodiment of the present invention.

First, at the time of creating a SIP connection request message, the image forming apparatus 101 sets a SIP address (sip: xxx@abc.co.jp) as a destination without adding attribute information.

Further, the image forming apparatus 101 sets m=image as a media type to create the SIP connection request message. On this occasion, not INVITE but ALLSEND is designated as a method (METHOD) type. The image forming apparatus 101 then transmits this SIP connection request message to the SIP server 102.

In the SIP server 102, the SIP control section 302a receives the SIP connection request message via the TCP/IP control section 301a (step S801). Then, the SIP message analyzing section 305 analyzes the SIP connection request message (step S802). During the analysis of the SIP connection request message, attribute information is not analyzed because no attribute information is included in the SIP connection request message.

In order to ascertain whether or not SIP URIs which are destinations have already been registered, the SIP message analyzing section 305 instructs the registration determining section 307 to make a determination as to registration. The registration determining section 307 determines whether or not destination addresses for the SIP connection request message have already been registered in the SIP URI storage section 308 (step S803).

When the registration determining section 307 determines that the destination addresses have not been registered (NO in the step S803), the SIP message analyzing section 305 bring the session establishing process to an end.

Here, in the SIP URI storage section 308, a SIP address “sip: xxx@abc.co.jp” is registered, and further, destination addresses “sip: 192.168.11.3”, “sip: 192.168.11.4”, and “sip: 192.168.11.5” are registered.

Thus, the registration determining section 307 determines that the destination addresses have been registered (YES in the step S803). Then, the SIP message creating section 303 transmits a SIP connection request message (INVITE) to all these destination addresses (step S804).

In the third embodiment, when ALLSEND is designated, the SIP server 102 performs the same processing as in the above described case where the CANCEL attribute is OFF. Then, the SIP message creating section 303a waits until it receives response messages from all the destinations (step S805).

Upon receiving response messages (OK) from all the destinations, the SIP message creating section 303a generates a connection response message. Then, the SIP control section 302a transmits the connection response message to the image forming apparatus 101 via the TCP/IP control section 301a (step 5806) and brings the session establishing process to an end.

Thus, in the third embodiment, only in the case where ALLSEND is designated as METHOD, a plurality of connections designated by destination addresses can be established by one SIP session, and therefore, for example, not only a fax can be broadcasted to a plurality of destinations, but also a IP phone call can be made while a fax is being broadcasted.

As is clear from the above description, in the example shown in FIG. 1, the image forming apparatus 101 is a transmitting-side terminal apparatus, and each of the image forming apparatuses 103 to 106 is a receiving-side terminal apparatus.

Moreover, in FIG. 3, the SIP control section 302a and the TCP/IP control section 301a act as a transmission unit. Further, the SIP message analyzing section 305 and the attribute information analyzing section 306 act as a determination unit. The SIP message creating section 303a, the registration determination section 307, the SIP control section 302a, and the TCP/IP control section 301a act as a session establishment unit.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-195043 filed Sep. 7, 2011, which is hereby incorporated by reference herein in its entirety.

What is claimed is:

1. A communication control apparatus that establishes a session in response to a connection request message received from a transmitting-side terminal apparatus via a network, and controls communication between the transmitting-side terminal apparatus and receiving-side terminal apparatuses, comprising:
a transmission unit configured to transmit a connection request message to destinations associated with an address included in the connection request message;
a determination unit configured to determine whether a predetermined designation is made as to the connection request message; and
a session establishment unit configured to, when said determination unit determines that the predetermined designation is made as to the connection request message, receive response messages from all of the receiving-side terminal apparatuses which are the destinations, then transmits a connection response message to the transmitting-side terminal apparatus, and connects all of the receiving-side terminal apparatuses which are the destinations and the transmitting-side terminal apparatus to each other by one session.

2. A communication control apparatus according to claim 1, wherein said session establishment unit establishes the session according to SIP.

3. A communication control apparatus according to claim 2, wherein when said determination unit determines that the predetermined designation is not made as to the connection request message, said session establishment unit receives a first response message from one of the receiving-side terminal apparatuses which are the destinations, then transmits the connection response message to the transmitting-side terminal apparatus, connects the receiving-side terminal apparatus from which the reply message was received first and the transmitting-side terminal apparatus to each other by one session.

4. A communication control apparatus according to claim 2, wherein the transmitting-side terminal apparatus sets the predetermined designation in the connection request message.

5. A communication control apparatus according to claim 2, further comprising a storage unit configured to store the destinations in association with the address.

6. A communication control apparatus according to claim 2, further comprising another storage unit configured to store the destinations in association with the address and also store the predetermined designation,
wherein by referring to said other storage unit based on an address included in the connection request message, said determination unit determines whether the predetermined designation is made.

7. A control method for a communication control apparatus that establishes a session in response to a connection request message received from a transmitting-side terminal apparatus via a network, and controls communication between the transmitting-side terminal apparatus and receiving-side terminal apparatuses, comprising:
a transmission step of transmitting a connection request message to destinations associated with an address included in the connection request message;
a determination step of determining whether a predetermined designation is made as to the connection request message; and
a session establishment step of, when it is determined in said determination step that the predetermined designation is made as to the connection request message, receiving response messages from all of the receiving-side terminal apparatuses which are the destinations, then transmitting a connection response message to the transmitting-side terminal apparatus, and connecting all of the receiving-side terminal apparatuses which are the destinations and the transmitting-side terminal apparatus to each other by one session.

8. A non-transitory computer-readable storage medium storing a control program for implementing a control method for a communication control apparatus that establishes a session in response to a connection request message received from a transmitting-side terminal apparatus via a network, and controls communication between the transmitting-side terminal apparatus and receiving-side terminal apparatuses, comprising:
a transmission step of transmitting a connection request message to destinations associated with an address included in the connection request message;
a determination step of determining whether a predetermined designation is made as to the connection request message; and
a session establishment step of, when it is determined in said determination step that the predetermined designation is made as to the connection request message, receiving response messages from all of the receiving-side terminal apparatuses which are the destinations, then transmitting a connection response message to the transmitting-side terminal apparatus, and connecting all of the receiving-side terminal apparatuses which are the destinations and the transmitting-side terminal apparatus to each other by one session.
